(19) United States
(12) Patent Application Publication
(10) Pub. No.: US 2002/0164031 A1
(43) Pub. Date: Nov. 7, 2002

(54) Devices

(76) Inventor: Lauri Piikivi, Oulu (FI)

Correspondence Address: PERMAN & GREEN, 425 POST ROAD, FAIRFIELD, CT, 06430, US

(21) Appl. No.: 09/928,026

(22) Filed: Aug. 10, 2001

(30) Foreign Application Priority Data
Aug. 15, 2000 (GB) 0020108.7

(51) Int. Cl. G06F 17/60

(52) U.S. Cl. 380/270; 705/65

(57) ABSTRACT

A device and method are disclosed which enables data transferred during a transaction to be protected. The device includes a connecting means for establishing a communication link with a second party and selection means connected to receive a control message from the second party. The control signal includes a plurality of selectable security protocols and in response to receiving this signal the device selects one of the security protocols. Information is subsequently transferred between the device and the second party using the selected security protocol to protect the transferred data.

The present invention relates to a device and a method for protecting data transferred during a purchase transaction carried out between a device and a second party. In particular, but not exclusively, the device may be a mobile device and the second party may be a merchant server.

Currently the internet offers access to many sites including the worldwide web WWW) at which a user might carry out a transaction with a merchant to purchase an item. One disadvantage is the perceived insecurity whereby users are concerned that payment information might be read by an unauthorised third party. These third parties might then use such information to purchase other items using the user's ID and credit facilities. Additionally retailers or other merchants are reluctant to offer items for sale because it is difficult for them to verify the identity of a user and also the credit worthiness of the user.

One way of overcoming these problems is to protect sensitive information by secure sockets layer (SSL) security. SSL is a coding system which encrypts data prior to transmission to a merchant who can then decrypt the data and complete a transaction. Such a system does not however provide either party to a transaction with any guarantees as to the identity of the parties. It also requires a user to type in certain information such as credit card numbers etc.

Another standard system which has been developed for performing secure transactions electronically is EMV. EMV payments over Internet is not current technology but rather EMV is for card-present situations at e.g. supermarkets. The EMV card is a smart card with an EMV application on it. EMV over Internet is not approved by banks etc, and allows merchants and banks to be assured of user and payment. The inventors have realised that it would be useful to have an EMV compliant mobile station (for example a mobile phone). With EMV capable phones EMV over internet becomes a potential payment method. EMV involves a user being issued with a smart card or integrated socket card (ICC) by a card issuer. The ICC specification for payment systems describes the minimum functionality required from these ICC cards and terminals operated by the merchants selling goods or services with which the ICC will cooperate. The terminals typically include an interface device (IFD), such as an ICC card reader, and the necessary hardware and software to enable communication between the terminal and ICC.

In use the EMV system utilises an initial authorisation message including an application cryptogram (ARQC) provided from the ICC which is read by a merchant terminal. The initial authorisation message includes data which allows the card to be authenticated, allows details of the card issuer to be provided. The terminal contacts the card issuer using this initial authentication message thus requesting authentication from the card issuer to complete the purchase of an item. Information on the transaction such as price and currency may be forwarded to the card issuer. The issuer responds with an authorisation response message followed by a clearing message as is known in the art. This either authorises the transaction or not. Security during such an electronic transaction is maintained via the application cryptogram. This encrypts or scrambles data which is then transmitted and descrambled at the receiving device using a decryption algorithm.

Another system which provides secure transactions and more details of the identity of the parties and which is applicable for use over the internet is the secure electronic transaction (SET) protocol. This SET standard enables secure payment transactions to be made over open networks. In addition integrity of all transmitted data is maximised as well as providing a means of authenticating both the user (a card holder) and a merchant operating an internet site. EMV and SET are security protocols in the sense that they permit secure payment. They are therefore effectively secure payment protocols.

In order to authenticate the user and merchant, the SET protocol enables the user and merchant to exchange associated digital certificates. These are issued to users and merchants registered with a certificate authority which is effectively a trusted third party organisation which is responsible for guaranteeing that the individual or organisation, users or merchants, are who they claim to be. The exchange of digital certificates, which are only given out once identities have been checked, thus enables user and merchant to validly identify each other at the beginning of an online transaction.

The SET protocol utilises a digital wallet which is in software form, protected via password/s which plugs into a user's web browser. During a transaction the digital wallet acts as a connection between the merchant and a banking network. The SET protocol validates a user/card holder transaction through use of a personal identification code or PIN. Whenever a user visits an internet site selling products using SET technology the SET digital wallet can be used to make a purchase. The digital wallet can store details of more than one credit card owned by a card holder by having the card numbers and expiration dates preprogrammed.

Once a user has an electronic wallet and digital certificate the user can access a site maintained by a merchant typically through a “store front” page on the internet. From this point a user identifies a product or item to be purchased then activates the electronic wallet, selects the credit card to be used and authorises payment. Goods purchased are thereafter despatched to the card holder and the cost of the goods deducted from the account of the card holder.

Mobile stations, such as, for example, mobile phones or pagers can now also be used to access the internet rather than merely via a personal computer (PC). These mobile stations makes use of the wireless application protocol (WAP). WAP is an open global specification which extends previously conceived and developed wireless data protocols and which gives mobile users with wireless devices the chance to access and interact with services on the world wide web and internet in general. An advantage of accessing the internet via a mobile station is that it is convenient and can contain prestored personal information such as favourite sites on the internet. This means that information can be found or purchases made conveniently. A subscriber with a WAP-compliant mobile phone makes use of an inbuilt microbrowser to make a request for access via the wireless markup language (WML) which has been derived particularly for wireless network characteristics. The request is transferred to a WAP gateway which retrieves required data from an internet server and send the requested data to the WAP user via the WAP gateway.

When it comes to purchasing items from the internet using a WAP compliant mobile phone one problem which occurs is that no current mobile phone exists which offers SET or EMV or any other high level security protocols as standard security provisions. (As explained, the inventors have realised that this would be desirable). Rather when a user of a mobile phone identifies an item to be purchased they must then type in, via their keypad, details of a credit card and a password. This is prone to abuse by unauthorised third parties. Furthermore another problem which might occur is that in the situation where some internet sites operate with the SET standard or EMV standard it would be necessary for the purchaser to identify which protocol should be used. This can be an unacceptable complication for the user. Furthermore a merchant offering goods for sale on the internet site would potentially be presented with an addressing problem of both a SET wallet server supported payment and an EMV payment being offered by any user.

It is an aim of embodiments of the present invention to at least partly mitigate the above-referenced problems.

According to a first aspect of the present invention there is provided a device comprising connecting means for establishing a connection with a second party; selection means connected to receive a control message signal from said second party and in response thereto to select one of a plurality of security protocols, whereby information transferred subsequently between the device and second party is protected using the selected security protocol.

Preferably the selection means further comprises analysis means which analyses the data contained in said control message signal and in response thereto selects the security protocol.

Conveniently the device further includescalculating means for generating an EMV cryptogram from data held in at least one data field of the control message signal.

Advantageously the device further includes cryptogram transmitting means provided to transmit the EMV cryptogram from the mobile station to initiate secure transfer of information from the device.

According to a second aspect of the present invention there is provided a device comprising connecting means for establishing a connection with a second party, selection means for selecting one of a plurality of security protocols and being connected to communicate said selection to said second party, whereby information transferred subsequently between the device and second party is protected using the selected security protocol.

According to a third aspect of the present invention there is provided a device comprising connecting means for establishing a connection with a second party, selection means for selecting a SET security protocol and being connected to communicate said selection to said second party, whereby information transferred subsequently between the device and second party is protected using the SET security protocol.

According to a fourth aspect of the present invention there is provided a device comprising connecting means for establishing a connection with a second party, selection means for selecting a EMV security protocol and being connected to communicate said selection to said second party, whereby information transferred subsequently between the device and second party is protected using the EMV security protocol.

This has the advantage that a mobile station has the facility inbuilt to allow a payment transaction to be authorised via the set standard automatically without a user having to make decisions about which system to use or to type in any data.

For a better understanding of the present invention and as to how the same may be carried into effect, reference will now be made by way of example only to the accompanying drawings in which:

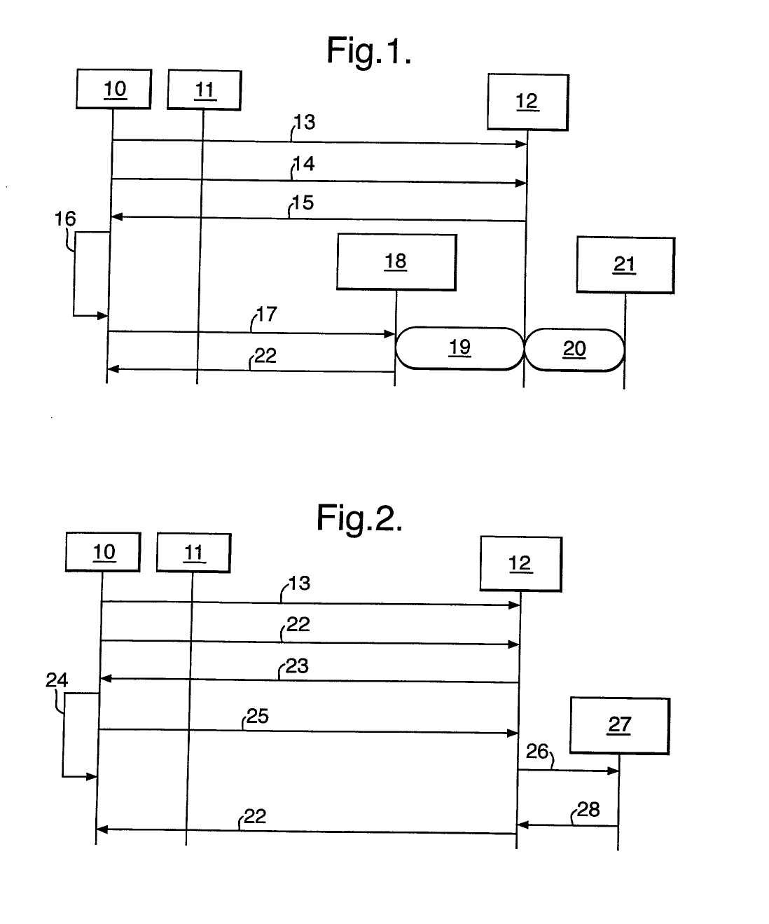

FIG. 1 illustrates EMV payment with SET card holder, server or SET wallet server support.

FIG. 2 illustrates EMV payment with merchant EMV support.

In the drawings like reference numerals refer to like parts.

FIG. 1 illustrates how a mobile phone 10 in accordance with a first embodiment of the present invention can communicate via a gateway 11 to a merchant server 12 serving an internet site operated by a merchant to thereby purchase an item from the merchant. The transaction, in FIG. 1, is authorised according to the SET standard.

The mobile phone 10 includes wireless application protocol (WAP) software and hardware which enables a subscriber of a wireless telecommunication network to use their mobile phone to access the internet. The WAP compliant phone includes a microbrowser which enables the user to browse the sites on the internet. One particular domain of the internet which can be accessed in this way is the world wide web (the web). Internet sites which are accessed are displayed on the screen of the mobile phone and a subscriber can interact with the site via the keypad/buttons on the mobile phone as known in the art.

In more detail the microbrowser inbuilt in the mobile phone makes a request using the wireless markup language (WML) for information from an internet server. This request is transmitted to the WAP gateway 11. The request is transferred between the mobile phone and gateway by various network elements (not shown) in a conventional manner. The WAP gateway is installed in the telecommunication network to which the mobile phone is connected to provide a gateway between the internet and the telecommunication network. The gateway thus receives input data from the merchant server 12 and processes it so that it can be transferred over the telecommunication network to the WAP user. For example if the input data from the merchant server is in HTML (hyper text markup language) the gateway 11 will translate it into a format for use in the network so that it can be passed to the mobile phone 10.

Thus, once a user browsing (represented by the line 13 between the mobile phone and the merchant server) the internet identifies a site at which a merchant is offering goods or services for sale which the subscriber wishes to purchase they can proceed to indicate their desire to purchase the item. This is done when the subscriber interacts with the internet site indicating a desire to purchase the item and pressing a button/key on the mobile phone to confirm that fact. This initiates remote payment from the browsing stage.

It is not known at this stage what form of security protocol can be supported by the merchant server and therefore what form of protocol messaging should be used. The mobile phone therefore requests payment startup 14 from the merchant server using a standard start payment signal. The merchant server 12 will respond with a payment initialisation message 15. This message indicates payment is to be carried out in accordance with the secure electronic transaction (SET) standard protocol. This initialisation stage 15 is processed in the mobile phone 10 for payment application purposes. The message is identified as SET protocol message and processed accordingly with SW in the phone. Data is taken from the message and given for the EMV application (on smart card, for example) to create the EMV cryptogram. As an alternative the merchant server 12 or internet site itself might indicate what form of payment standard should be used. This could indicate the fact to the user who could program the fact into the mobile phone. In this situation the payment startup message 14 can be modified to indicate whether SET or EMV or other security protocols should be used.

The standard SET payment initialisation message 15 includes a succession of fields each of which contains data indicating characteristics of the transaction and which consists of the elements making up the total message. For example one field might contain details of valid card types or transaction amounts or currency types. This is set out in the associated standard.

Responsive to the initialisation message 15 the mobile phone 10 begins processing using either an integrated circuit card (ICC) or onboard software. This is illustrated as card handling 16. The mobile phone operates a modified SET standard in which the connection 17 between the mobile phone 10 and a modified SET wallet 18 is carried out utilising an EMV type transaction. This is because a basic SET transaction would require use of hardware to generate the signals which would be too heavy to be in the mobile phone. In other words the hardware would be incompatible with the small size mobile technologies demanded by today's markets. For this reason an EMV signal is used. This provides adequate security between the mobile phone and modified wallet 18. Furthermore the signals and encryption can be provided during the card handling 16 which uses an embedded ICC or software which is physically small and light enough to be in a mobile phone.

The card handling step 16 includes the creation of the EMV cryptogram which is utilised to encrypt the details of the transaction to provide security. The data required to provide the EMV cryptogram is contained in the payment initiation signal 16 which is received from the merchant server 12. Thus the mobile phone has the basic cryptogram information which in conjunction with the information from the merchant server is used to generate the EMV cryptogram. The data from the merchant may include details of the merchant, of the transaction itself such as cost and any other suitable data. Once the EMV cryptogram has been calculated in the handling stage 16 it is forwarded to the SET wallet server 18 together with the SET payment initialisation message 17. The modified wallet server is a standard SET wallet server adapted to communicate with a user using an EMV cryptogram encoded signal and with a network via the standard SET protocol. Since the wallet server is placed in the network the hardware and software required to generate the SET transaction signals are not required to be carried via the mobile unit.

The modified SET wallet server 18 receives the payment initialisation message 17 and EMV cryptogram and from this is able to establish the required data to enable a subsequent SET transaction between the wallet, merchant and payer in accordance with normal SET standards. This includes a first stage of communication 19 between the wallet and merchant server and a second stage of communication 20 between the merchant server 12 and a SET payment gateway 21. These stages do not affect the user and any communications from merchant to SET gateway are not seen by the SET wallet server. The SET wallet server does not contact the SET gateway by itself and does not have to know which gateway the merchant uses. There are possibly multiple messages between the merchant and SET wallet server to exchange security certificates. SET wallet server makes a digital signature of the payment data and user's credit card information for merchant. Merchant gives this data to SET gateway for authorization. Gateway gives the data for the acquirer (merchant's) bank who checks the signature etc. The method of money transfer between the user's card issuing bank and acquirer is not specified, banks have many methods for it. The merchant may proceed before having a response from SET gateway, but the acquirer informs through the SET gateway if the transaction was authorized or rejected. After the payment gateway 21 has indicated whether the transaction has been successful or not the result is communicated via the merchant server 12 and wallet server 18 to the subscriber at the mobile phone 10 via an acknowledge result message 22.

In this way the transaction certificates used for the SET standard can be sent to the merchant server 12 via the wallet server. By having the SET payment initialisation signal contain enough information to create the EMV cryptogram using an external EMV application or access to such an application on a smart card in the phone the mobile phone itself does not have to have the complex, large and slow protocol required to communicate between phone and wallet according to the normal SET standard. By having a modified SET wallet server (or SET card holder server) which can operate responsive to an EMV cryptogram the subsequent parts of the transaction between the wallet 18, merchant server 12 and payment gateway 21 can be in accordance with the basic SET standard.

FIG. 2 illustrates how a mobile phone 10 in accordance with a second embodiment of the present invention can communicate via a gateway 11 to a merchant server 12 serving an internet site which is able to authorise a payment transaction according to the EMV standard. The mobile phone 10 includes WAP technology which enables a subscriber of the wireless telecommunication network using the phone 10 to browse the internet. The mobile phone 10, gateway 11, and merchant server 12 operate in a similar manner to that described in relation to FIG. 1.

Once the user browsing (indicated by line 13 between the phone and merchant server) the internet identifies a site at which a merchant is offering goods or services for sale or hire which the subscriber wishes to purchase they can proceed to indicate their desire to purchase the item. This is done when the subscriber interacts with the internet site indicating a desire to purchase the item by pressing the button on the mobile phone.

This initiates a request for payment startup message 22 which is sent from the mobile station to the merchant server 12. This signal can either be of a standard type in which case the merchant server 12 responds with a payment initialisation message 23 which indicates that payment is to be carried out in accordance with the EMV standard or alternatively the mobile phone 10 may already be provided with the information that the merchant server supports only EMV transactions. In this case the startup message 22 could be adapted to refer specifically to the startup of an EMV transaction.

In order to indicate that the merchant server supports EMV transactions the payment initialisation message 23 is a modified SET message. The difference in architecture, ie the ability of the merchant server to accept SET or EMV transactions can be notified in an additional field in the standard SET payment initialisation message. This modified initialisation message 23 can alternatively include an additional or a modification of an existing SET data field from the standard SET payment initialisation message 15. For example the standard SET specification specifies a field SET-brand which is transferred from the merchant to client informing the user whether Visa, Master Card or other card be used and giving a URL for a logo. This field can be modified to have the text “EMV” and URL for the merchant address. Or a new field EMV-merchant with URL as value may be added to the message.

NO MODIFICATIONS
MIME-Version: 1.0┘
Content-Type: text\plain┘
Content-Transfer-Encoding: Binary┘
SET-Initiation-Type: Payment-Initiation┘
SET-SET-URL: http:\\www.merchant.com\cgi-bin\doset.exe┘
SET-Query-URL: http:\\www.merchant.com\cgi-bin\pay-query.exe┘
SET-Success-URL: http:\\www.merchant.com\pay-completion.html┘
SET-Failure-URL: http:\\www.merchant.com\pay-failure.html┘
SET-Cancel-URL: http:\\www.merchant.com\cancel-order.html┘
SET-Service-URL: http:\\www.merchant.com\cust-service.html┘
SET-Version: 1.0┘
SET-PurchAmt: 840 250 −2┘
SET-LID-M: A53F49┘
SET-Brand: brand1 <http:\\www.brand1.com\logo\>┘
SET-Brand: brand2 <http:\\www.brand2.com\logo\>┘
MODIFICATION
MIME-Version: 1.0┘
Content-Type: text\plain┘
Content-Transfer-Encoding: Binary┘
SET-Initiation-Type: Payment-Initiation┘
SET-SET-URL: http:\\www.merchant.com\cgi-bin\doset.exe┘
SET-Query-URL: http:\\www.merchant.com\cgi-bin\pay-query.exe┘
SET-Success-URL: http:\\www.merchant.com\pay-completion.html┘
SET-Failure-URL: http:\\www.merchant.com\pay-failure.html┘
SET-Cancel-URL: http:\\www.merchant.com\cancel-order.html┘
SET-Service-URL: http:\\www.merchant.com\cust-service.html┘
SET-Version: 1.0┘
SET-PurchAmt: 840 250 −2┘
SET-LID-M: A53F49┘
SET-Brand: brand1 <http:\\www.brand1.com\logo\>┘
SET-Brand: EMV <http:\\www.merchant.com\emv:8888> OR
EMV-Merchant: <http:\\www.merchant.com\emv:8888>┘

As may be seen the difference between the two architectures is the additional EMV-Merchant field or modified SET-Brand fields. In each of these the web address of the merchant is selected as being the address which is specified (provided by the merchant) for EMV transactions. This modified standard SET payment initialisation message 23 informs the mobile phone that the merchant server cannot support SET standard transactions. As a result the EMV security protocol is used in the subsequent communication. In response to the modified initialisation message 23 the EMV internal application in the mobile phone (which might be software or a smart card inside the phone) begins handling the transaction. This is illustrated as the card handling process 24.

In contrast to the system of FIG. 1 the SET initialisation message 17 is not required because the SET wallet is not utilised. This is effectively indicated via the modified field of the initialisation message 23. This initialisation message 23 indicates that the mobile phone 10 should contact the merchant server 12 using the EMV security protocol.

In order to do this the EMV card handling process 24 calculates an EMV cryptogram for use in encrypting and decrypting the transferred data. The EMV cryptogram is calculated using data from the modified SET payment initialisation message 23 and information stored in the mobile phone 10 itself. This is similar to that described in relation to FIG. 1. Once calculated this EMV cryptogram can be communicated to the merchant server using an open session message 25. Thereafter the merchant server 12 and mobile phone 10 can communicate together via the gateway 11 as is known in the art utilising various signals (not shown). This includes a purchase request signal 26 from the merchant server 12 to a card issuer internet payment gateway (IPGW) 27. This is via standard EMV protocol signals. The gateway forwards the message to the card issuer server. The card issuer can then authorise a transaction depending upon the credit rating or status of the subscriber's account. The result 28 of this authorisation is transmitted to the merchant server via the IPGW 27. The merchant server 12 then notifies the user (would-be purchaser) via a standard acknowledge result message 22. It will be understood that the IPGW is only one of a number of ways in which merchants and/or banks could be contacted.

In this way the existing SET and EMV standards can be used for conducting purchase transactions over an open network such as the internet via a mobile phone. This is particularly advantageous to maximise security when shopping over the world wide web. Embodiments of the invention utilise the information in a set payment initialisation message to create an EMV cryptogram. The set payment initialisation message can also be modified to support EMV payments directly to the merchant thus removing the necessity for a SET wallet server or card holder server. Embodiments of the invention thus solves the problem of typing in the needed payment information to a mobile phone. It also solves the addressing problem by providing a single point of contact using a single type of initialisation signal from the merchant servers.

In embodiments of the invention existing SET standards in the field of mobile phones can be used with some modification. Likewise a mobile phone can use existing EMV standards by having an internal EMV application in the mobile phone. In the mobile phone the SET initialisation message is modified so as to support EMV payments directly. The SET payment initialisation message contains the information to create the EMV card generated cryptogram (ARQC).

Although the embodiments of the invention have been described in respect of WAP any alternative (such as the SIM application tool kit,) wireless protocol that enables similar functionality to WAP could be used.

Also as an alternative the modified SET wallet server could be provided in the mobile phone itself. The SET wallet server can store the information relating to the user's credit cards in the server itself. This information is normally stored on a smart card within a phone (SIM or secondary smart card) for EMV applications. The EMV applications might alternatively run on a secure IC in the phone.

Although mobile phones have been described throughout the specification the skilled man will realise that any form of mobile device, for example pagers or the like, could be utilised.

Embodiments of the present invention need not be used with a mobile device but can also be used with fixed devices. The fixed device can be a computer or any other suitable device which could be filled with smart card readers or the like.

The skilled man will also realise that further modifications could be made without departing from the scope of the present invention.

What is claimed is:

1. A device comprising:
connecting means for establishing a communication link with a second party;
selection means connected to receive a control message signal from said second party said signal including a plurality of selectable security protocols and in response thereto to select one of the plurality of security protocols; whereby
information transferred subsequently between the device and second party is protected using the selected security protocol.

2. A device according to claim 1 wherein said selection means further comprises:
analysis means which analyses the data contained in said control message signal and in response thereto selects the security protocol.

3. A device according to claim 1 further comprising:
calculating means for generating an EMV cryptogram from data held in at least one data field of the control message signal.

4. A device according to claim 3 further comprising cryptogram transmitting means provided to transmit the EMV cryptogram from the mobile station to initiate secure transfer of information from the device.

5. A device according to claim 1 further comprising:
means to provide a start payment signal from the device to the second party which thereby initiates the control message signal from the second party.

6. A device according to claim 1 further comprising:
means for communicating, when said selected security protocol is the SET standard, with a modified SET wallet server which is adapted to receive an EMV cryptogram generated by the device and thereafter to communicate with a SET
payment gateway via the second party according to the SET standard.

7. A device station according to claim 1 further comprising:
means for communicating, when said selected security protocol is the EMV standard, with the second party directly via an EMV cryptogram generated via the
device.

8. A device according to claim 1 wherein the control message signal comprises a series of data fields each containing data indicating a predetermined parameter for the transaction.

9. A device according to claim 1 wherein the control signal includes a data field which indicates whether the device can communicate directly with the second party or with the second party via a modified SET wallet.

10. A device according to claim 1 further comprising:
internet browsing circuitry which enables a user of the device to access and browse the internet via the device.

11. A device according to claim 10 wherein said connecting means enables a connection to be established between said device and a second party via the internet.

12. A device according to claim 1 wherein said device comprises a mobile station.

13. A device according to claim 1 wherein said second party comprises a merchant server associated with a merchant offering an item to be purchased.

14. A device comprising:
connecting means for establishing a communication link with a second party;
selection means for selecting one of a plurality of security protocols and being connected to communicate said selection to said second party; and
calculating means for generating an EMV cryptogram for transmittal from said device; whereby
information transferred subsequently between the device and second party is protected using the selected security protocol.

15. A device comprising:
connecting means for establishing a communication link with a second party;
selection means for selecting a SET security protocol and being connected to communicate said selection to said second party; and
calculating means for generating an EMV cryptogram for transmittal from said device; whereby
information transferred subsequently between the device and second party is protected using the SET security protocol.

16. A device comprising:
connecting means for establishing a communication link with a second party;
selection means for selecting a EMV security protocol and being connected to communicate said selection to said second party; whereby
information transferred subsequently between the device and second party is protected using the EMV security protocol.
